(19) United States
(12) Patent Application Publication
(10) Pub. No.: US 2005/0083930 A1
(43) Pub. Date: Apr. 21, 2005

(54) Method of early buffer release and associated MAC controller

(76) Inventors: Jen-Kai Chen, Sindian City (TW); Wen-Chung Tsai, Keelung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/967,199

(22) Filed: Oct. 19, 2004

(30) Foreign Application Priority Data
Oct. 20, 2003 (TW) 09129049

(51) Int. Cl. H04L 12/56

(52) U.S. Cl. 370/389

(57) ABSTRACT

A method of early release of buffers and a related media access control chip are disclosed, wherein the method includes the steps of: receiving an Ethernet packet from a port, allocating a buffer area having a plurality of buffers stitched sequentially for storing the Ethernet packet, transmitting the Ethernet packet from the destination port, and releasing the buffers when the transmission starts if the destination port is full-duplex transmission mode, or releasing the buffers after at least 128 bytes of the packet is transmitted if the destination port is half-duplex transmission mode. The Ethernet packet can be either uni-cast, multi-cast or broadcast.

### BACKGROUND OF THE INVENTION

1. Field of the Invention

The present invention generally relates to a method of early buffer release and an associated media access control MAC controller and more particularly, to a method used in Ethernet switches for early buffer release and an associated Ethernet MAC controller.

2. The Related Art

An Ethernet switch is capable of performing multi-port networking, with each port having a line speed of 10 M/100 M/1000 M full-duplex transmission. The core of the Ethernet switch is a MAC controller, which is typically responsible for the second and third layers operation in the seven-layer network structure. The MAC is coupled to the physical layer (PHY) to provide the multi-port network connection and is in charge of transceiving the physical signals with the remote end. MAC temporarily stores the packets received by all the ports, and forwards those packets to the designated ports. The MAC might utilize external memory chips or built-in memory, for example 128 K-byte SRAM, for the temporary packet buffering. As an Ethernet switch typically has 8-port, 16-port, or 24-port and the limited memory must be shared by all those ports for packet buffering and forwarding, the effective use of memory is, therefore, very important.

The packets can be classified uni-cast, multi-cast, or broadcast. A uni-cast packet is received by one port of the Ethernet switch and forwarded to another port. The multi-cast packet is received by one port of the Ethernet switch and transmitted from a plurality of other ports. The broadcast packet is received by one port of the Ethernet switch and transmitted from all the other ports. In general, the maximum Ethernet packet is typically 1522-byte long. However, in the NAS/SAN system, a jumbo packet of 9.6 K bytes is allowed. Several jumbo packets may occupy the entire built-in 128 K-byte memory and cause the congestion in the network switch.

The MAC uses external or built-in memory for temporarily buffering packets. The MAC includes a forwarding control unit, a queue control unit, a buffer control unit, and a port control unit. The buffer control unit configures the external or built-in memory during the initialization to establish appropriate data structure and format for later use.

FIG. 1 shows an Ethernet packet 100. The Ethernet packet 100 includes a destination MAC address (DMAC) 110, a source MAC address (SMAC) 120, a payload 130, and a cyclic redundant code (CRC) 140. A “buffer” occupies a pre-defined size in the memory. The buffer control unit allocates several buffers from memory to store the received Ethernet packet 100. A buffer area comprises one or more buffers. For example, a buffer can be defined as 128-byte. When a 256-byte Ethernet packet 100 enters the Ethernet switch, it takes two buffers to store the packet. Therefore, the buffer area is 256-bytes. When a 260-byte Ethernet packet 100 enters the Ethernet switch, it takes three buffers to store the packet. Hence, the buffer area is 384-bytes. When a 1522-byte Ethernet packet 100 enters the Ethernet switch, it requires 12 buffers to store the packet. The buffer area is 1536-bytes. A plurality of buffers may be stitched to form a buffer area to store a packet conventionally, the buffer area released after Ethernet packet 100 completes the transmission.

FIG. 2 shows a typical structure of a buffer area for buffering Ethernet packets. The buffer area includes a plurality of buffers 200, 210, 220, 230. The buffers 200-230 are stitched sequentially, and each buffer 200-230 has a link node 202, 212, 222, 232, respectively. First buffer 200 uses link node 202 to point to second buffer 210, and second buffer 210 uses link node 212 to point to third buffer (not shown), and so on. The serial number of second buffer 210 can be written into link node 202 of the first buffer 200 so that the first buffer 200 may point to second buffer 210 through the link node 202. This is called “stitch”. For example, an Ethernet switch with a built-in 128 K-byte memory can be programmed as 1024 buffers, each being 128-bytes. In this case, ten bits are sufficient to indicate the serial numbers of buffers.

### SUMMARY OF THE INVENTION

The present invention provides an early release method of buffers, including the steps of: receiving an Ethernet packet from a port, allocating a buffer area having a plurality of buffers stitched sequentially for storing the Ethernet packet, transmitting the Ethernet packet from the destination port, and releasing the buffers when the transmission starts if the destination port is full-duplex transmission mode, or releasing the buffers after at least 128 bytes of the packet is transmitted if the destination port is half-duplex transmission mode. The Ethernet packet can be either uni-cast, multi-cast or broadcast.

The present invention further provides a media access MAC controller, including a plurality of port control unit for coupling a physical layer control chip, a forwarding control unit for coupling port control units, a queue control unit for coupling the forwarding control unit and port control units, and a buffer control unit for coupling a buffer memory and port control units. Each port control unit has a counter for counting the length of the packet that is already transmitted, and a transmission mode register for recording the transmission capability. The port control unit, based on the counter and the transmission mode register, sends signals to the buffer control unit to early release the buffers. When the port control unit receives an Ethernet packet, the buffer control unit allocates a buffer area having a plurality of buffers to store the Ethernet packet. If the transmission mode register shows that the port control unit is full-duplex transmission mode, the (N−1)th buffer can be released as soon as the port control unit starts to transmit N-th buffer, where N is any integer greater than 1. If the transmission mode register shows that the port control unit is half-duplex transmission mode, the (N−1)th buffer can be released as soon as the port control unit starts to transmit N-th buffer, where N is any integer greater than 1.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention will be apparent to those skilled in the art by reading the following description of preferred embodiments thereof, with reference to the attached drawings, in which:

FIG. 1 shows a structure of an Ethernet packet;

FIG. 2 shows a typical structure of a buffer area for storing an Ethernet packet;

FIG. 3 shows a flowchart of the method of early release of buffers of the present invention; and

FIG. 4 shows a hardware block diagram according to an embodiment of the present invention

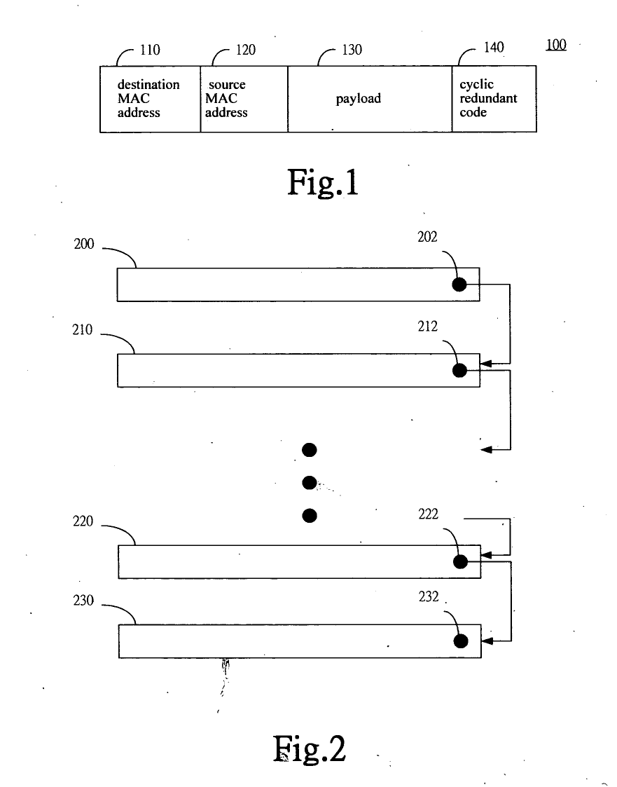

### DETAILED DESCRIPTION OF THE PREFERRED EMBODIMENT

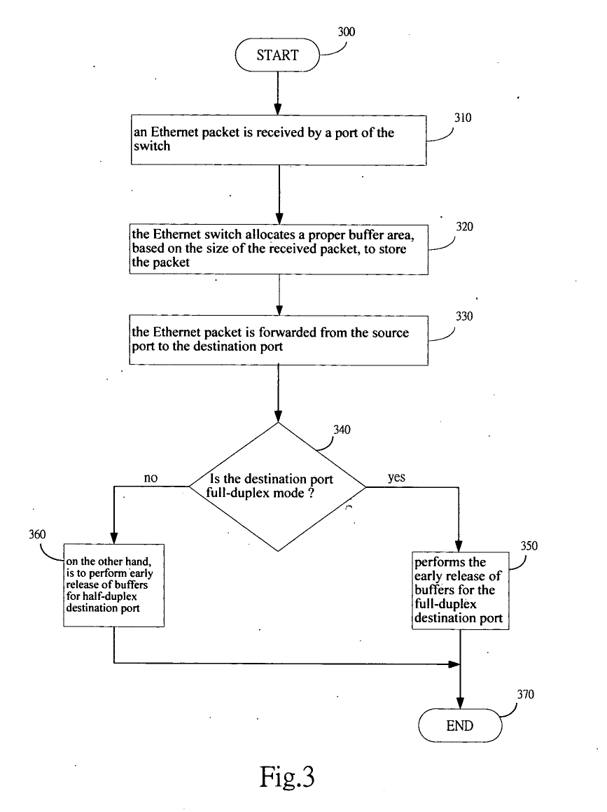

FIG. 3 shows a flowchart of a method of early release of buffers in accordance with the present invention, using an Ethernet switch with a plurality of ports and a memory as an embodiment for explanation. The method starts with step 300. In step 310, an Ethernet packet is received by a port of the switch. In step 320, the Ethernet switch allocates a proper buffer area, based on the size of the received packet, to store the packet. The Ethernet switch may manage the buffers by numbering and stitching, for example, according to the structure shown in FIG. 2. Thus, the allocated buffer area includes a plurality of buffers 200, 210, . . . , 220, 230 for storing the data of the packet. The Ethernet packet can be either uni-cast, multi-cast, or broadcast. This embodiment is herein exemplified by uni-cast packets, which specifie the DMAC and SMAC address. In step 330, the Ethernet packet is forwarded from the source port to the destination port. Step 340 determines if the destination port is full-duplex mode. If it is full duplex, step 350 is taken; otherwise, step 360 is taken. Step 350 performs the early release of buffers for the full-duplex destination port. The Ethernet switch forwards the buffers 200, 210, . . . , 220, 230 sequentially. When the destination port is full duplex, the buffer 200 can be released as soon as it is forwarded while buffer 210 starts being forwarded. Similarly, when buffer 220 starts being forwarded, buffer 210 can be released. Because the port operates in the full-duplex mode, there exists no packets collision. Therefore, when the N-th buffer starts being forwarded, the (N−1)-th buffer can be released, where N is any integer greater than 1. Step 360, on the other hand, is to perform early release of buffers for half-duplex destination port. The Ethernet switch sequentially forwards buffers 1, 2, 3, . . . , (N−2), (N−1), and N. When the destination port is half-duplex, the early release of buffer can be carried out after forwarding a pre-determined number of buffers. Preferably, the early release of buffer starts after 128 bytes are forwarded. For example, if the buffer size is 128-byte, the release of first buffer starts when the first buffer finishes forwarding and the second buffer starts forwarding. Therefore, after the N-th buffer forwarding, the (N−1)-th buffer can be released, where N is any integer greater than 1. In this embodiment, the buffer size is 128-byte, and the Ethernet requires no collision occurring of transmitting 64 bytes according to CSMA/CD protocol. If the CSMA/CD transmission standard is violated, the so-called ‘late collision’ occurs between the 64- byte and 128-byte duration. Therefore, in half-duplex mode, preferably the first buffer is released after the second buffer starts forwarding. In another embodiment, the buffer size is defined as 64- byte, the release of the first buffer and the second buffer can be performed after the third buffer starts forwarding. When the N-th buffer starts forwarding, the (N−1)-th buffer can be released where N is integer greater than 2. In a hardware embodiment, the actual forwarded size can be determined according to the number of buffers and the buffer size. Each buffer mode can be early-released after completing forwarding full duplex. However, buffers in half-duplex mode can be early released for storing other Ethernet packets after 128 bytes are forwarded. If an ultra-late collision occurs later than 128 bytes, it is preferably to drop the packet transmission to improve the hardware efficiency. The re-transmission cannot be performed because the buffers have been released.

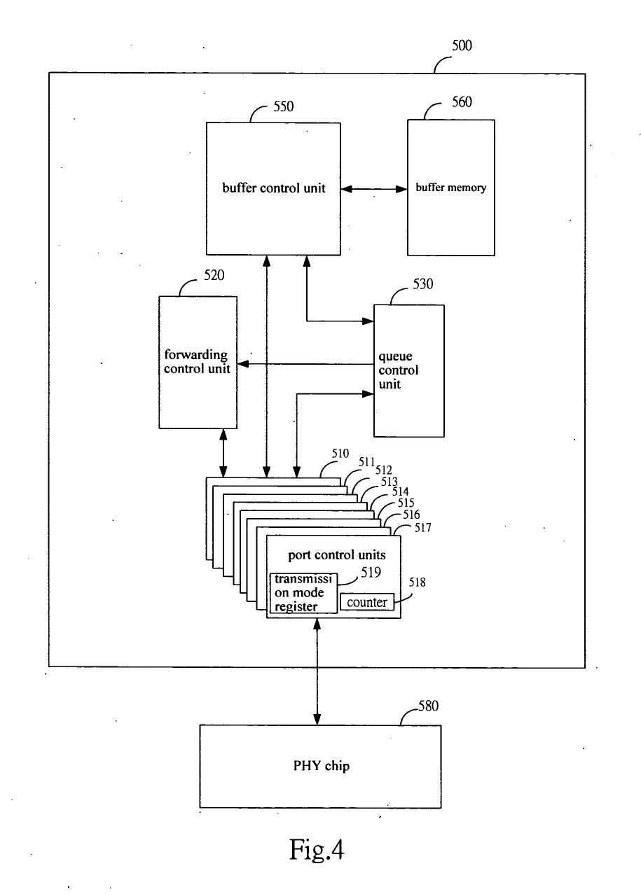

FIG. 4 shows a hardware block diagram according to the embodiment of the present invention. An Ethernet switch includes a media access MAC controller 500, and a physical layer (PHY) circuit 580. Preferably, MAC 500 couples PHY chip 580 through reduced medium independent interface (RMII). MAC chip 500 includes port control units 510-517 corresponding to port 0 to port 7 of an 8-port Ethernet switch, a forwarding control unit 520, a queue control unit 530, a buffer control unit 550, and a buffer memory 560. The buffer control unit 510 is coupled to the forwarding control unit 520, the queue control unit 530 and the buffer control unit 550. The buffer control unit 550 is coupled to the buffer memory 560. The PHY chip 580 is responsible for transceiving of physical electrical signal for the switch. The method disclosed above is related to the internal operation of the MAC chip 500. A packet received by port 0 of the Ethernet switch, through the PHY chip 580, arrives the port control unit 510, and the forwarding control unit 520 generates an associated port mask, according to, a look-up table, for example. The buffer control unit 550 allocates an appropriate number of buffers from the buffer memory 560 to temporarily store the packet. The queue control unit 530 enqueues the packet according to the port mask. Queue control unit 530 may determine, based on the output queue length of each port, the congestion status, and properly signals the port control unit 510 to perform an appropriate congestion control. Each of the control units 510-517 has a transmission mode register, individually.

Furthermore, the Ethernet switch performs the auto-negotiation mechanism and records the transmission capability of remote connection ports in the transmission mode registers when the ports start establishing the network link. As each port control unit has a counter for counting the length of the already-transmitted portion of packet, the counter restarts counting when a new packet starts its transmission. For example, the port control unit 517 has a counter 518 for counting the already-transmitted packet length and a transmission mode register 519 for recording the transmission capability of the remote connection port. Preferably, the counter 518 starts to count when the port control unit 517 starts to transmit a new packet. If the transmission mode register 519 indicates that the port 517 is full duplex, and the associated port mask of the packet indicates that the port 517 is the last port for transmission of the packet while the counter 518 reaches the count of 64, the buffer that is already transmitted can be immediately released. If the transmission mode register 519 indicates that the port 517 is half-duplex, and the associated port mask of the packet indicates that the port 517 is the last port for transmission of the packet while the counter 518 reaches the count of 128, the buffer that is already transmitted can be immediately released. The present invention is suitable for the jumbo packets of NAS/SAN since it avoids occupying the space-limited memory too long.

The embodiment illustrated in FIG. 4 can be modified by persons skilled in the art in accordance with different manufacturing integration. For example, the buffer storage 560 can be integrated with the MAC chip 500, or as an add-on chip. Depending on the access speed, the buffer storage 560 can be SRAM, SDRAM, or DDR memory. The PHY chip 580, due to the special manufacturing process and providing physical layer control for a plurality of ports, is preferably an external chip. However, as the integration improves in the future, it is possible to integrate the PHY chip 580 into the MAC chip 500.

In summary, the present invention discloses a method of early release of buffers, comprising the following steps: receiving an Ethernet packet from a port, allocating a buffer area having a plurality of buffers stitched sequentially for storing the Ethernet packet, transmitting the Ethernet packet from the destination port, and releasing the buffers when the transmission starts if the destination port is full-duplex transmission mode, or releasing the buffers after at least 128 bytes of the packet is transmitted if the destination port is half-duplex transmission mode. The Ethernet packet can be either uni-cast, multi-cast or broadcast.

The present invention further provides a media access MAC controller, including a plurality of port control unit for coupling physical layer control chip, a forwarding control unit for coupling port control units, a queue control unit for coupling the forwarding control unit and port control units, and a buffer control unit for coupling a buffer memory and port control units. Each port control unit has a counter for counting the length of the packet that is already transmitted, and a transmission mode register for recording the transmission capability. The port control unit, based on the counter and the transmission mode register, sends signals to the buffer control unit to early release the buffers. When the port control unit receives an Ethernet packet, the buffer control unit allocates a buffer area having a plurality of buffers to store the Ethernet packet. If the transmission mode register shows that the port control unit is full-duplex transmission mode, the (N−1)th buffer can be released as soon as the port control unit starts to transmit N-th buffer, where N is any integer greater than 1. If the transmission mode register shows that the port control unit is half-duplex transmission mode, the (N−1)th buffer can be released as soon as the port control unit starts to transmit N-th buffer, where N is any integer greater than 1, and the buffer size is greater than 128 bytes. If the buffer size is less than 128 bytes, it is preferably to release the (N−2)-th buffer when the port starts to transmit the N-th buffer, where n is any integer greater than 2.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

1. A method of early release of buffers, comprising the steps of:
(a) receiving an Ethernet packet from a port;
(b) allocating a buffer area having a plurality of buffers stitched sequentially for storing the Ethernet packet;
(c) transmitting the Ethernet packet from a destination port; and
(d) releasing the buffers when the buffers being transmitted if the destination port being full-duplex transmission mode.

2. The method as claimed in claim 1, wherein the Ethernet packet is a uni-cast packet.

3. The method as claimed in claim 1, wherein the Ethernet packet is a multi-cast packet.

4. The method as claimed in claim 1, wherein the buffer is 128-byte long.

5. A method of early release of buffers, comprising the following steps:
(a) receiving an Ethernet packet from a port;
(b) allocating a buffer area having a plurality of buffers stitched sequentially for storing the Ethernet packet;
(c) transmitting the Ethernet packet from a destination port; and
(d) releasing the buffers when a pre-determined length of the packet being transmitted if the destination port being half-duplex transmission mode.

6. The method as claimed in claim 5, wherein the Ethernet packet is a uni-cast packet.

7. The method as claimed in claim 5, wherein the Ethernet packet is a multi-cast packet.

8. The method as claimed in claim 5, wherein the pre-determined length is 64- byte long.

9. The method as claimed in claim 5, wherein the pre-determined length is 128-byte long.

10. A media access MAC controller, comprising:
a plurality of port control units for coupling a physical layer control chip;
a forwarding control unit for coupling the port control units;
a queue control unit for coupling the forwarding control unit and the port control units; and
a buffer control unit for coupling a buffer memory and the port control units;
where each port control unit having a counter for counting the length of a packet having already transmitted and a transmission mode register for recording transmission capability of the port, and the port control unit, based on the counter and the transmission mode register, sending signals to the buffer control unit to early release the buffers.

11. The MAC chip as claimed in claim 10, wherein the port control unit receives an Ethernet packet, the buffer control unit allocates a buffer area having a plurality of buffers to store the Ethernet packet

12. The MAC chip as claimed in claim 11, wherein the port control unit, based on the counter and the transmission mode register, sends signals to the buffer control unit to early release the buffers, and when the transmission mode register shows that the port control unit is full-duplex transmission mode, an (N−1)th buffer can be released as soon as the port control unit starts to transmit an N-th buffer, where N is any integer greater than 1.

13. The MAC chip as claimed in claim 11, wherein the port control unit, based on the counter and the transmission mode register, sends signals to the buffer control unit to early release the buffers, and when the transmission mode register shows that the port control unit is half-duplex transmission mode, an (N−1)th buffer can be released as soon as the port control unit starts to transmit an N-th buffer, where N is any integer greater than 1, and the size of the buffer is greater than 128 bytes.

14. The MAC chip as claimed in claim 11, wherein the port control unit, based on the counter and the transmission mode register, sends signals to the buffer control unit to early release the buffers, and when the transmission mode register shows that the port control unit is half-duplex transmission mode, an (N−2)th buffer is released as soon as the port control unit starts to transmit an N-th buffer, where N is any integer greater than 1, and the size of the buffer is less than 128 bytes.

15. The MAC chip as claimed in claim 11, wherein the port control unit, based on the counter and the transmission mode register, sends signals to the buffer control unit to early release the buffers, and when the transmission mode register shows that the port control unit is half-duplex transmission mode, a transmitted the buffer can be released only when the port control unit has transmitted a pre-determined length of the packet.

16. The MAC chip as claimed in claim 15, wherein the pre-determined length is 128-byte long.
